(19) United States
(12) Patent Application Publication
(10) Pub. No.: US 2011/0020493 A1
(43) Pub. Date: Jan. 27, 2011

(54) Method For Manufacturing Korean Hot Pepper Paste Using Watermelon

(75) Inventors: Ki-ok Park, Jeollabukdo (KR); Jeong-bin An, Jeollabukdo (KR); So-jin An, Jeollabukdo (KR)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignees: Sunnongwon Agricultural Management Cooperation, Gimje-si (KR); Ki-ok Park, Gimje-si (KR)

(21) Appl. No.: 12/711,229

(22) Filed: Feb. 23, 2010

(30) Foreign Application Priority Data
Jul. 21, 2009 (KR) 10-2009-0066317

(51) Int. Cl. A23L 1/186

(52) U.S. Cl. 426/28

(57) ABSTRACT

Provided is a method for manufacturing Korean hot pepper paste using watermelon, and more particularly, a method for manufacturing Korean hot pepper paste using watermelon without using water and syrup, or sugar, which is a method for manufacturing a healthful watermelon hot pepper paste by adding glucose, fructose, and amino acid flavor that watermelon contains to eliminate the unpleasant odor that meju (Korean-style dried, fermented soybeans formed in brick-shaped clusters) powder has in traditional Korean hot pepper paste, adding taste with sugars contained in watermelon, and highlighting the color of the hot pepper paste using a lycopene ingredient.

### CROSS-REFERENCE TO RELATED APPLICATIONS

This application claims priority under 35 U.S.C. §119 to Korean Patent Application No. 10-2009-0066317, filed on Jul. 21, 2009, the disclosure of which is incorporated herein by reference in its entirety.

### TECHNICAL FIELD

The present disclosure relates to a method for manufacturing Korean hot pepper paste using watermelon, and more particularly, to a method for manufacturing Korean hot pepper paste using watermelon without using water and syrup, or sugar, which is a method for manufacturing a healthful watermelon hot pepper paste by adding glucose, fructose, and amino acid flavor that watermelon contains to eliminate the unpleasant odor that meju (Korean-style dried, fermented soybeans formed in brick-shaped clusters) powder has in traditional Korean hot pepper paste, adding taste with sugars contained in watermelon, and highlighting the color of the hot pepper paste using a lycopene ingredient.

### BACKGROUND

In general, Korean hot pepper paste manufactured by traditional manufacturing methods of Korean hot pepper paste using meju (Korean-dried, fermented soybeans formed in brick-shaped clusters) powder does not have a sweet taste, is astringent, is flavorless or has a particular unpleasant odor, and has a heavy taste due to its manufacture by mixing ingredients such as syrup, etc.

In order to vary and improve the taste of Korean hot pepper paste, a method of making watermelon hot pepper paste using watermelon is disclosed in Korean Patent Publication No. 10-2005-0118249 entitled “METHOD OF MAKING FERMENTED WATERMELON RED PEPPER PASTE BY ADDITION OF WATERMELON INSTEAD OF WATER WITHOUT USING CORN SYRUP OR SUGAR”.

The above-mentioned method relates to a method of making watermelon hot pepper paste using watermelon, which is a method of making watermelon hot pepper paste using the watermelon juice and flesh instead of water to get sweet and palatable tastes with the watermelon juice and flesh instead of syrup. This is about a technology for making watermelon hot pepper paste by mixing watermelon, meju powder, red chili powder, glutinous rice powder, salt, and soybean sauce as additives and may eliminate some problems such as astringency or unpleasant odor, arising from hot pepper manufacturing by conventional methods due to use of watermelon flavor as an ingredient.

Although the manufacture of Korean hot pepper paste using water melon has been known as described above, there still remain many considerations to improve upon for the manufacture of satisfactory quality watermelon hot pepper paste. With respect to, for example, storability, processibility, manufacturing economy, productivity, use of additives, etc., a new method for manufacturing Korean hot pepper paste by quantifying the considerations is required to manufacture uniform quality watermelon hot pepper paste which maintains a suitable quality, is constant and stable, and satisfies the palates of average consumers.

### SUMMARY

Accordingly, the present disclosure provides a method of manufacturing Korean hot pepper paste, which eliminates the heavy taste that conventional Korean hot pepper paste particularly has by using the watermelon flesh and juice instead of water and syrup to get sweet taste, improves the apparent quality by highlighting the color of the hot pepper paste, and removes unpleasant odor such as the smell of meju powder smell emitted from the red hot pepper and produces watermelon flavor in the manufacture of the hot pepper paste.

According to an aspect of the present invention, there is provided a Korean hot pepper paste to be used as a health supplementary food in a various range of applications by mixing the watermelon juice without using any water which is essential to the manufacture of traditional Korean hot pepper paste such that an average palate may be satisfied by mixing natural sweet taste with palatable tastes, and providing sweet taste and fatigue-relieving pharmacological functions which watermelon ingredients have.

In order to solve the problems and achieve the objects, a method for manufacturing watermelon red pepper paste, includes:

washing the surface of a watermelon and collecting the seeds, separating 100 parts by weight of the edible portion from the rind portion of the watermelon to grind it into particles;

placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;

placing 100 parts by weight of the juice separated from the step in a container to simultaneously mix 10 parts by weight of malt and filter residues using a mesh;

soaking 50 parts by weight of glutinous rice in water for about at least 3 hours, placing it into an autoclave to prepare hard cooked rice, and then mixing the hard cooked rice in a mixture of the liquid juice and malt yielded in the juice and malt mixing step and placing it into a thermo pot to ferment the hard cooked rice;

squeezing out the liquid of the liquid juice and malt by using a mesh after the hard cooked rice is fermented through the step, decanting the filtered liquid malt into a pot, boiling it at 105-115° C. in the range of about 90-120 min until a thin syrup film is formed, and then turn the heat when the juice, malt, and hard cooked rice becomes about 130 parts by weight to cool down the temperature to about 40° C.;

adding about 10 to 20 parts by weight of meju powder into the liquid malt, placing about 30 to 45 parts by weight of red chili powder prepared in about 2 hours, primarily applying a material for adjusting saltiness which includes sodium chloride as a main ingredient, and aging it for about at least 24 hours as a pre-aging step; and

adjusting the concentration and saltiness again in about at least 24 hours and placing it into a pot to be aged while stirring it once in about a week for about 90 days as a long-term aging step to obtain about 190 parts by weight of a finished Korean hot pepper paste.

The temperature at which the fermentation is performed in the hard cooked rice fermentation step is about 50° C. to 65° C., and the time to ferment the rice is about 6 hr to about 8 hr.

The sodium chloride ingredient used to adjust saltiness is one selected from the group consisting of refined salt and Korean soybean sauce.

### DETAILED DESCRIPTION OF EMBODIMENTS

Hereinafter, preferred embodiments of the present invention will be described in detail.

In describing the present invention, detailed description about related known functions or structures will be omitted if the detailed description may unnecessarily obscure the substance of the present invention.

A method for manufacturing Korean hot pepper paste according to preferred embodiments of the present invention includes washing the surface of a watermelon and collecting the seeds, separating 100 parts by weight of the edible portion from the rind portion of the watermelon to grind it into particles; placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight; placing 100 parts by weight of the juice separated from the step in a container to simultaneously mix 10 parts by weight of malt and filter residues using a mesh; soaking 50 parts by weight of glutinous rice in water for about at least 3 hours, placing it into an autoclave to prepare hard cooked rice, and then mixing the hard cooked rice in a mixture of the liquid juice and malt yielded in the juice and malt mixing step and placing it into a thermo pot to ferment the hard cooked rice; squeezing out the liquid of the liquid juice and malt by using a mesh after the hard cooked rice is fermented through the step, decanting the filtered liquid malt into a pot, boiling it at 105-115° C. in the range of about 90-120 min until a thin syrup film is formed, and then turn the heat when the juice, malt, and hard cooked rice becomes about 130 parts by weight to cool down the temperature to about 40° C.; adding about 10 to 20 parts by weight of meju powder into the liquid malt, placing about 30 to 45 parts by weight of red chili powder prepared in about 2 hours, primarily applying a material for adjusting saltiness which includes sodium chloride as a main ingredient, and aging it for about at least 24 hours as a pre-aging step; and adjusting the concentration and saltiness again in about at least 24 hours and placing it into a pot to be aged while stirring it once in about a week for about 90 days as a long-term aging step to obtain about 190 parts by weight of a finished Korean hot pepper paste.

Also, the temperature at which the fermentation is preferably performed in the hard cooked rice fermentation step is about 50° C. to 65° C., and the time to ferment the rice is preferably about 6 hr to about 8 hr. If the fermentation temperature is too high, it is possible to reduce the time to ferment the rice. However, as the rice was fermented for a sufficiently long time, it was observed that the quality of the hard cooked rice increased. The suitable time to ferment the hard cooked rice in the present invention was about 50° C. to about 65° C. When the cooking is performed for about 6 hr to about 8 hr in the temperature range, a hard cooked rice appropriate for manufacturing Korean hot pepper paste was obtained.

The sodium chloride ingredient used to adjust the saltiness is preferably one selected from the group consisting of refined salt and Korean soybean sauce.

According to the present invention, watermelon hot pepper paste was manufactured using watermelon juice or juice and flesh instead of water and syrup. Because moisture which watermelon contains is used without using any water which is commonly used, a watermelon hot pepper paste which is not only excellent in sugar content by fatigue-reliever ingredients fructose and glucose that watermelon has and the action of amino acids containing citicoline, but also fine-colored by lycopene ingredient which is known to be effective in aging prevention may be obtained.

The ingredient analysis results of a watermelon hot pepper paste manufactured according to the present invention are summarized in the following <Table 1>.

TABLE 1

| Item | Result | Item | Result |
|---|---|---|---|
| Calories | 194.26/100 g | Saturated fat | 0.1 g/100 g |
| Carbohydrate | 47.98 g/100 g | Trans fat | 0.0 g/100 g |
| Moisture | 42.62% (±0.93) | Cholesterol | 0.0/100 g |
| Ash | 4.76% (±0.04) | Sugars | 24.18 g/100 g |
| Crude protein | 4.34% (±0.04) | Crude fiber | 4.43% (±0.03) |
| Crude fat | 0.3% (±0.00) | | |

The color of watermelon is expressed as a peculiar color of watermelon and the hot pepper paste does not include peculiar astringent taste or heavy taste of conventional hot pepper paste. Because the hot pepper paste includes sufficient watermelon flavor, a peculiar unpleasant odor of hot pepper paste was not detected.

It was confirmed that the taste of hot pepper paste was improved and enriched by natural sugars, such as glucose and fructose, and amino acid ingredients which watermelon contains without using water and syrup as an additive to increase sugar content, as factors which eliminate astringent taste or heavy taste of conventional hot pepper paste.

It was confirmed that the color of Korean hot pepper paste depends on turbidity according to the amount of various input materials including red chili powder, but the lycopene ingredient in watermelon ingredients changed the color to be similar to that of watermelon. It was also confirmed that the fine and clear color perceived by the naked eyes were devoid of the aversive response that conventional hot pepper paste solicited.

The present invention may be used as a health supplementary food in a various range of applications by using watermelon juice which contains a lot of water instead of water and syrup and adding natural sweet taste obtained from watermelon and healthful ingredients that watermelon contains as ingredients for Korean hot pepper paste. The present invention has little peculiar astringent taste which the paste has, leaves little aftertaste, has substantially no unpleasant odor, includes watermelon flavor, is easy to eat due to its fine color, and may contribute to the commercialization of Korean hot pepper paste due to its healthfulness by using natural ingredients.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for manufacturing Korean hot pepper paste, comprising:
washing the surface of a watermelon and collecting the seeds, separating 100 parts by weight of the edible portion from the rind portion of the watermelon to grind it into particles;
placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;
placing 100 parts by weight of the juice separated from the step in a container to simultaneously mix 10 parts by weight of malt and filter residues using a mesh;
soaking 50 parts by weight of glutinous rice in water for about at least 3 hours, placing it into an autoclave to prepare hard cooked rice, and then mixing the hard cooked rice in a mixture of the liquid juice and malt yielded in the juice and malt mixing step and placing it into a thermo pot to ferment the hard cooked rice;
squeezing out the liquid of the liquid juice and malt by using a mesh after the hard cooked rice is fermented through the step, decanting the filtered liquid malt into a pot, boiling it at 105-115° C. in the range of about 90-120 min until a thin syrup film is formed, and then turn the heat when the juice, malt, and hard cooked rice becomes about 130 parts by weight to cool down the temperature to about 40° C.;
adding about 10 to 20 parts by weight of meju powder into the liquid malt, placing about 30 to 45 parts by weight of red chili powder prepared in about 2 hours, primarily applying a material for adjusting saltiness which includes sodium chloride as a main ingredient, and aging it for about at least 24 hours as a pre-aging step; and
adjusting the concentration and saltiness again in about at least 24 hours and placing it into a pot to be aged while stirring it once in about a week for about 90 days as a long-term aging step to obtain about 190 parts by weight of a finished Korean hot pepper paste.

2. The method of claim 1, wherein the temperature at which the fermentation is performed in the hard cooked rice fermentation step is about 50° C. to 65° C., and the time to ferment the rice is about 6 hr to about 8 hr.

3. The method of claim 1, wherein the sodium chloride ingredient used to adjust saltiness in the pre-aging step and the long-term aging step is one selected from the group consisting of refined salt and Korean soybean sauce.
